(19) United States
(12) Patent Application Publication
(10) Pub. No.: US 2003/0159671 A1
(43) Pub. Date: Aug. 28, 2003

(54) Outboard motor

(76) Inventors: Tomonori Ikuma, Wako-shi (JP); Masanori Tsubouchi, Wako-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/367,135

(22) Filed: Feb. 14, 2003

(30) Foreign Application Priority Data
Feb. 22, 2002 (JP) 2002-46920

(51) Int. Cl. F02M 35/10

(52) U.S. Cl. 123/184.53

(57) ABSTRACT

An outboard motor having an intake silencing box provided above a cylinder block in communication with combustion chambers is provided. The intake silencing box has left and right air induction passages located forwardly of exhaust passages and extending vertically downwardly between the exhaust passages and a skirt of a crankcase in a suspended fashion. The lower ends of the air induction passages open downwardly.

### FIELD OF THE INVENTION

The present invention relates to an outboard motor having an intake silencing box which constitutes an intake silencer.

### BACKGROUND OF THE INVENTION

Outboard motors without intake silencers and outboard motors with their intake openings directed toward the hulls produce intake noises which are transmitted directly to the manipulators and hence noisy.

Intake silencers are thus provided in intake passages to reduce intake noises. An outboard motor with such a conventional intake silencer is disclosed in, for example, Japanese Patent Laid-Open Publication No. HEI-8-310487.

The conventional intake silencer is disposed in an intake system of an engine of the outboard motor. The intake silencer takes air in from laterally opposite sides of a throttle body provided in a front and laterally generally middle portion within an engine space of the outboard motor. The total cross-sectional area of the two air inlets of the intake silencer is equal to or greater than the cross-sectional area of an intake passage of the throttle body, securing a sufficient amount of intake, reducing the dimension of one air inlet, and thus increasing space efficiency.

The arrangement disclosed in HEI-8-310487 has an air inlet portion located relatively closely to the front part of the engine. In some cases, however, no space is available for the air inlet portion.

### SUMMARY OF THE INVENTION

The present invention has been made to solve the above problem and has an object of providing an outboard motor causing no interference between an exhaust passage and an air inlet portion in a portion of the outboard motor other than a portion closer to the front of the engine, regardless of the presence of the exhaust passage at the side of a cylinder head.

It is another object of the present invention to provide an outboard motor with a V-engine in a plan view which can utilize the contour of the V-engine to put an intake silencing box within the opening width dimension of the V shape, securing a sufficient volume of an expansion chamber and a sufficient intake opening of the intake silencing box, preventing increase in the size of the intake silencing box, and increasing noise-reduction efficiency.

It is a particular object of the present invention to provide an outboard motor with an intake silencing box which allows the use of an intake silencing box of a large volume while avoiding increase in the size of the intake silencing box, and allows preferable intake of air into the intake silencing box.

It is another object of the present invention to provide an outboard motor which allows a rational arrangement of an intake silencing box constituting an intake silencer, an alternating-current generator (ACG) and other components.

According to an aspect of the present invention, there is provided an outboard motor having a four-stroke engine, which comprises: a generally vertically extending crankshaft; a cylinder block constituting part of a crankcase housing the crankshaft, the cylinder block having a plurality of generally horizontal cylinders; a cylinder head connected to a rear surface of the cylinder block to form a plurality of combustion chambers; an exhaust passage provided at one side of the cylinder head in communication with the combustion chambers; an intake passage provided at the other side of the cylinder head in communication with the combustion chambers; and an intake silencing box provided above the cylinder block in communication with the combustion chambers via the inlet passage, wherein the intake silencing box has an air induction passage disposed forwardly of the exhaust passage and extending vertically downwardly between the exhaust passage and a skirt portion of a crankshaft space in a suspended fashion, the air induction passage having an air inlet opening downwardly.

Since the air induction passage of the intake silencing box is disposed forwardly of the exhaust passage and extends downwardly between the exhaust passage and the skirt of the crankshaft space in a suspended fashion, interference between an exhaust pipe constituting the exhaust passage and the inlet passage is prevented. It is thus possible to provide an intake silencing box of a large volume while avoiding increase in the lateral size of the outboard motor and reducing the outer size of the outboard motor.

In order to secure a sufficient steering angle especiallly when two outboard motors are fixed in parallel to the stern, it is required to reduce the lateral dimension of the outboard motors, reducing space in the front of the engines. This invention provides an outboard motor of a small width dimension fulfilling the requirement, requiring less space in the front.

Since the air induction passage of the intake silencing box is extended downward between the exhaust passage and the skirt of the crankshaft space with the inlet opened, the flow of air into the intake silencing box first moves upward from the inlet and then enters the silencing chamber. This prevents water to enter the intake silencing chamber, regardless of the location of an air inlet of an engine cover.

Preferably, the engine comprises a V-engine with the vertically adjacent cylinders forming a rearward-opening V shape as viewed from the top. The cylinders are thus arranged to the shape of angled cylinders of the V-engine, providing a sufficient volume, avoiding increase in the lateral size of the outboard motor, and reducing the size of the outboard motor with the large-volume engine.

According to another aspect of the present invention, there is provided an outboard motor having a four-stroke engine, which comprises: a generally vertically extending crankshaft; right and left cylinder blocks forming part of a crankcase housing the crankshaft, the cylinder block having a plurality of generally horizontal cylinders vertically adjacent to one another and diverging rearwardly into a V-shape in top plan; cylinder heads connected to rear surfaces of the cylinder blocks to form a plurality of combustion chambers; right and left intake passages provided at inner sides of the cylinder heads in communication with the combustion chambers; a generator disposed forwardly of the crankcase; and an intake silencing box provided above the cylinder blocks in communication with the combustion chambers via the intake passages, wherein the intake silencing box has air induction passages disposed forwardly of exhaust passages located at outer sides of the cylinder heads and extending vertically downwardly between the exhaust passages and a skirt of a crankshaft space in a suspended fashion, the air induction passages having inlets opening downwardly.

The outboard motor thus arranged allows the use of an intake silencer most suitable for a 4-stroke V-engine outboard motor of a large volume and a reduced lateral size, allowing the rational arrangement of an intake system, generator and other components.

### BRIEF DESCRIPTION OF THE DRAWINGS

Preferred embodiments of the present invention will be described in detail below, by way of example only, with reference to the accompanying drawings, in which:

FIG. 1 is a side view of the appearance of an outboard motor according to the present invention;

FIG. 2 is a partially cross-sectional side view of an engine, showing an engine cover of the outboard motor shown in FIG. 1 in vertical cross-section;

FIG. 3 is a horizontally-cross-sectional plan view of an upper portion of the outboard motor with an upper portion of the engine cover shown in horizontal cross-section;

FIG. 4 is a horizontally-cross-sectional plan view with an intake silencing box shown in FIG. 3 removed, showing in cross-section one inlet passage of the intake silencing box and showing the other in imaginary lines; and

FIG. 5 is a perspective view showing the entire body of the intake silencing box according to the present invention.

### DETAILED DESCRIPTION OF THE PREFERRED EMBODIMENTS

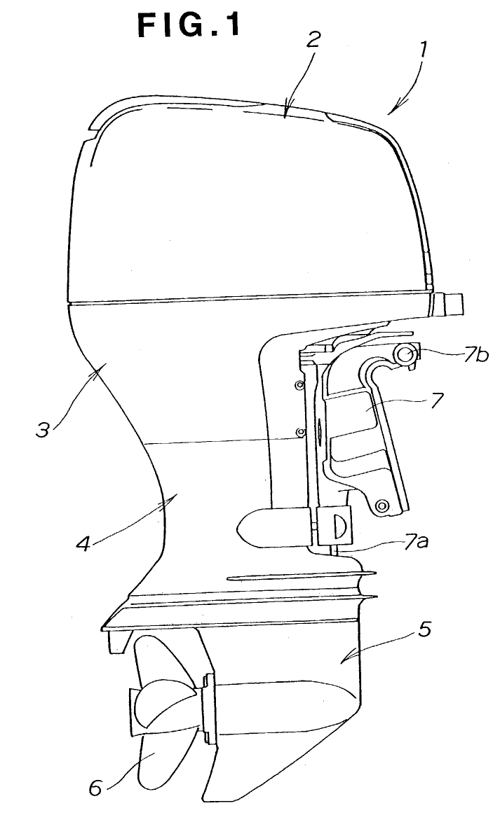

Referring to FIG. 1, an outboard motor 1 has an uppermost engine cover 2, an undercover 3 disposed below the engine cover 2, an extension case 4 extended vertically below the under cover 3, a gearcase 5 provided below the extension case 4, and a screw 6 oriented rearward. The outboard motor 1 is mounted to a hull of a boat, not shown, via a stern bracket 7. The outboard motor 1 can be moved laterally (for steering) and vertically (upward and downward) via a steering shaft 7a and a tilt shaft 7b.

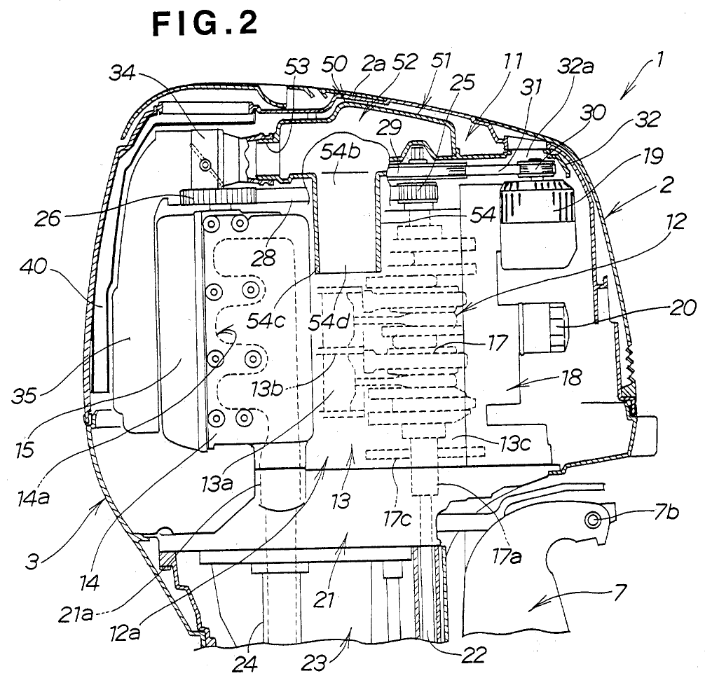

Reference is now made to FIG. 2 which is a partially cross-sectional side view of an engine with the engine cover of the outboard motor shown in vertical section.

The outboard motor 1 has an engine 12 accommodated in an engine space 11 enclosed by the engine cover 2 constituting the exterior.

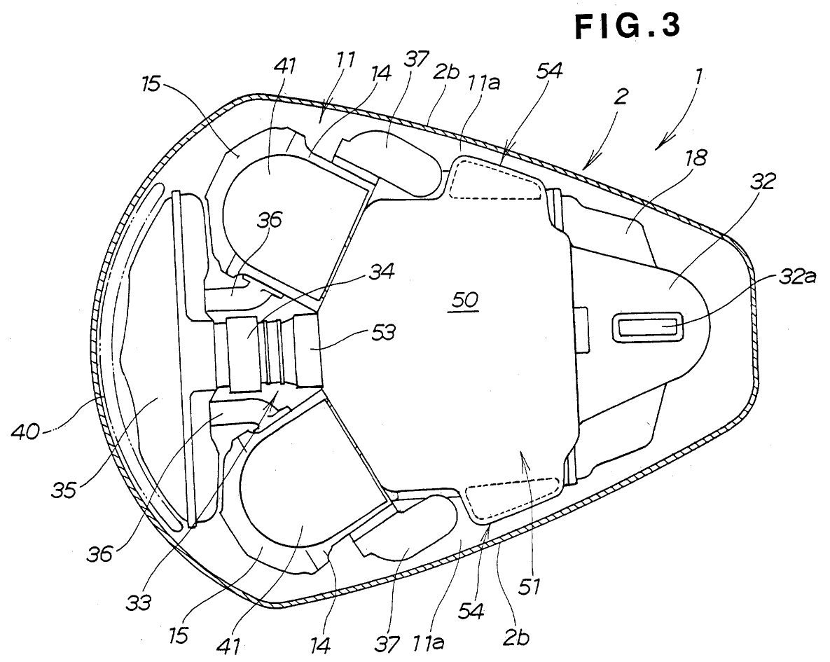

The engine 12 has a V configuration as viewed in top plan and has diverging right and left cylinder blocks 13, in which a plurality of generally horizontal cylinders 13b with a plurality of pistons 13a fitted therein are arranged vertically (see FIGS. 2 and 3).

A cylinder head 14 is provided at the rear end of each cylinder block 13 (left in FIG. 2). A cylinder head cover 15 is provided at the rear end of each cylinder head 14.

Each of the left and right cylinder blocks 13, 13 has a plurality of horizontal cylinders 13b aligned vertically. Known combustion chambers not shown are formed between the cylinder heads 14, 14 of the cylinders 13b and the left and right cylinder blocks 13, 13.

The front of each cylinder block 13 has a front-half portion 13c (skirt of the cylinder block) housing a crankshaft 15 disposed in a generally vertical orientation. At the front of the front-half portion 13c, a crankcase 18 is provided.

The front-half portion 13c and the crankcase 18 form a crankshaft space housing the crankshaft 17 therein.

At a lower portion of the vertically-extending crankshaft 17 is provided a flywheel 17c which meshes via its peripheral ring gear with a driven gear of a starter to start the engine 12.

A generator 19 (ACG) is mounted to a front upper end portion of the crankcase 18 located on the right of the front-half portion 13c (skirt) of the cylinder block 13 (in a front part of the outboard motor). An oil filter 20 is mounted below the generator 19.

A bottom 12a of the engine 12 is supported on a mount case 21 disposed within the undercover 3. A lower end portion 17a of the crankshaft 17 extends vertically downward of the mount case 21 and is connected to the upper end of a drive shaft 22 vertically extending through the extension case 4 (see FIG. 1). The lower end of the drive shaft 22 is connected to a gearbox to drive the screw 6 disposed in the gearcase 5 shown in FIG. 1.

In the Figure, reference numeral 23 denotes an oil pan disposed below the mount case 21 located below the bottom 12a.

The cylinder head 14 has an exhaust passage 14a provided inside. As shown in FIG. 3, left and right exhaust manifolds 37, 37 are extended downward from the sides of the cylinder heads 14, 14. The exhaust manifolds 37, 37 are connected to left and right exhaust pipes 24, 24. The lower end of the exhaust passage 14a of the cylinder head 14 is connected for communication to the upper end of an exhaust passage 21a extended vertically through the mount case 21. Upper portions of the exhaust pipes 24, 24 substantially vertically extend through the mount case 21 and extend along the laterally opposite sides of the oil pan 23 (because of the locations of the left and right cylinder heads 14, 14 of the V-engine in a plan view). The exhaust pipes 24, 24 extend vertically downward.

Exhaust passages are configured such that downstream portions of the exhaust passages 14a, 14a within the cylinder heads 14, 14 consist of the exhaust manifolds 37, 37, the exhaust passages 21a, 21a within the mount case 21 and the exhaust pipes 24, 24, further extending through the extension case 4 and opening into the water.

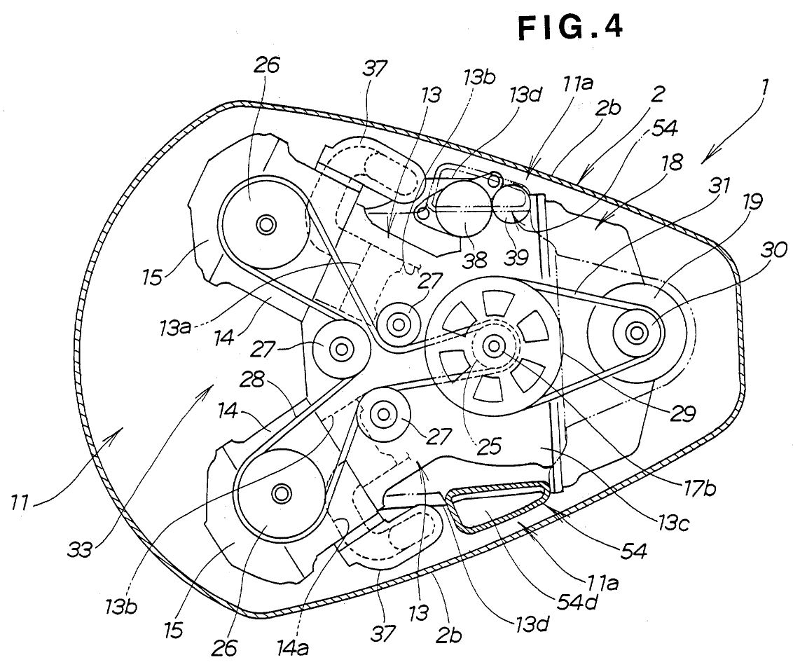

A top end portion 17b (see FIG. 4) of the crankshaft 17 is protruded from the top surface of the front-half portion 13c of the cylinder block 13. A camshaft drive pulley 25 (see FIG. 2) is fixed to the top end portion 17b. Camshaft driven pulleys 26, 26 are disposed above the left and right cylinder heads 14, 14 arranged on the left in FIG. 2.

As shown in FIG. 4, a timing belt 28 is looped around the pulleys 25, 26 and 26 via a plurality of intermediate pulleys 27.

The crankshaft 17 is driven to drive the camshaft via the pulley 25, belt 28 and pulleys 26, 26.

At an upper end portion of the crankshaft 17 above the pulley 25 is provided a coaxial generator drive pulley 29 (see FIG. 4) which is connected via a belt 31 to a generator pulley 30 disposed above the generator 19, to drive the generator 19 with the crankshaft 17. Above the generator pulley 30 is provided a belt cover 32 shown in FIG. 2.

An intake silencing or muffling box 50 constituting part of a fuel supply system is provided in a longitudinally middle portion of the engine space 11 within the engine cover 2, below a top surface 2a of the engine cover 2 and above a part of the belt-pulley transmission 25 to 31 located above the cylinder block 13 of the engine 12.

The intake silencing box 50 will be described in detail below with reference to FIGS. 2 to 5.

The intake silencing box 50 has, as shown in FIG. 2, an expansion chamber 52 of a large volume inside a body 51. The body 51 having the expansion chamber 52 inside is shaped like a flat box of a large lateral dimension (in the width direction of the outboard motor) and has a tubular air outlet 53 in a laterally middle portion of the rear end.

The outlet 53 is, as shown in FIG. 3, connected via a grommet or the like to an inlet passage of a throttle body 34 disposed in an area above V-banks 33 of the left and right cylinder heads 14, 14.

The throttle body 34 is connected for communication to an intake manifold 35 disposed rearward of the V-banks 33, extending vertically therebetween to distribute fuel to the combustion chambers via intake pipes or passages 36, 36.

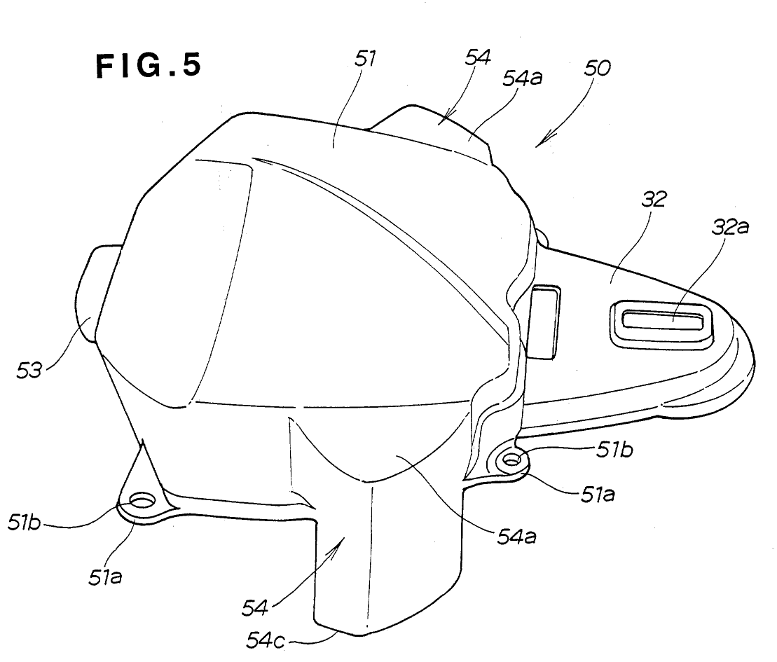

The belt cover 32 is mounted to the front end of the body 51 of the intake silencing box 50. An inlet 32a for taking cooling air into the engine space 11 is formed in a middle portion of the belt cover 32. As shown in FIG. 5, the body 51 is formed at its four peripheral corners with a plurality of mounting portions 51a each having a mounting hole 51b. The intake silencing box 50 is mounted on the top surface of the cylinder block 13 via the mounting portions 51a.

As shown in FIGS. 4 and 5, air induction passages 54, 54 as tubular passages for taking air in are provided at the laterally opposite sides of the body 51 of the intake silencing box 50. The air induction passages 54, 54 each have an upper end portion 54a which communicates as an inner downstream passage portion 54b (see FIG. 2) with the expansion chamber 52.

The air induction passages 54, 54 are located outward of the left and right side walls of the body 51. The top end portions 54a, 54a are bent at right angles downward with respect to the body 51 and extended vertically downward at a predetermined length from the opposite outer sides of the body 51. Lower end portions 54c thereof are formed with inlets 54d, 54d for taking air in. The inlets 54d, 54d open downward (see FIG. 2). The inlet passages 54, 54 are oriented downward in left and right side spaces 11a, 11a within the engine space 11, outside the laterally opposite outer sides of the cylinder block 13 and inside two sides 2b, 2b (see FIG. 3) of the engine cover 2.

As shown in FIGS. 3 and 4, the exhaust pipes 24, 24 are connected to downstream portions of the exhaust manifolds 37, 37 which are connected to the exhaust passages of the left and right cylinder heads 14, 14. The exhaust manifolds 37, 37 thus constitute upstream portions of the exhaust passages.

The upstream exhaust passages including the exhaust manifolds 37, 37 are located in the side spaces 11a, 11a within the engine space 11, rearward of the air induction passages 54, 54 provided at the opposite sides of the body 51 of the intake silencing box 50. The air induction passages 54, 54 of the intake silencing box 50 are thus located forward of the exhaust passages.

The air induction passages 54, 54 are located forward of the exhaust pipes 24, 24 at the opposite outer sides of the body 51 of the intake silencing box 50 disposed on the top surface of the cylinder block 13, being extended vertically downward from an upper portion of the cylinder block 13 to its middle portion on the opposite sides of the cylinder block 13.

The engine 12 is narrower in width at its upper portion located above a vertically-middle portion of the cylinder block 13 than its lower portion. The lower portion provides wide portions 13d, 13d. The cylinder block 13 is fixed at the lower ends of the wide portions 13d, 13d onto the mount case 21. A hollowed area proximately above one wide portion 13d is used to dispose a starter motor 38 and a starter relay 39.

An intake guide 40 shown in FIGS. 2 and 3 introduces air into the engine cover 2.

Belt covers 41, 41 shown in FIG. 3 cover the camshaft pulleys 26, 26 and the belt 28 disposed above the left and-right cylinder heads 14, 14.

The present disclosure relates to the subject matter of Japanese Patent Application No. 2002-046920, filed Feb. 22, 2002, the disclosure of which is incorporated herein by reference in its entirety.

What is claimed is:

1. An outboard motor having a four-stroke engine, comprising:
a generally vertically extending crankshaft;
a cylinder block constituting part of a crankcase housing said crankshaft, said cylinder block having a plurality of generally horizontal cylinders;
a cylinder head connected to a rear surface of said cylinder block to form a plurality of combustion chambers;
an exhaust passage provided at one side of said cylinder head in communication with said combustion chambers;
an intake passage provided at the other side of said cylinder head in communication with said combustion chambers; and
an intake silencing box provided above said cylinder block in communication with said combustion chambers via said inlet passage,
wherein said intake silencing box has an air induction passage disposed forwardly of said exhaust passage and extending vertically downwardly between said exhaust passage and a skirt of a crankshaft space in a suspended fashion, said air induction passage having an air inlet opening downwardly.

2. An outboard motor according to claim 1, wherein said engine comprises a V-engine with said vertically adjacent cylinders diverging rearwardly into a V shape as viewed in top plan.

3. An outboard motor with a four-stroke engine, comprising:
a generally vertically extending crankshaft;
right and left cylinder blocks forming part of a crankcase housing said crankshaft, said cylinder block having a plurality of generally horizontal cylinders vertically adjacent to one another and diverging rearwardly into a V shape as viewed in top plan;
cylinder heads connected to rear surfaces of said cylinder blocks to form a plurality of combustion chambers;
right and left intake passages provided at inner sides of said cylinder heads in communication with said combustion chambers;
a generator disposed forwardly of said crankcase; and
an intake silencing box provided above said cylinder blocks in communication with said combustion chambers via said intake passages,
wherein said intake silencing box has air induction passages disposed forwardly of exhaust passages located at outer sides of said cylinder heads and extending vertically downwardly between said exhaust passages and a skirt of a crankshaft space in a suspended fashion, said air induction passages having inlets opening downwardly.
